(19) United States
(12) Patent Application Publication
(10) Pub. No.: US 2024/0289861 A1
(43) Pub. Date: Aug. 29, 2024

(54) GENERATING QUERIES FOR USERS OF AN ONLINE SYSTEM USING LARGE LANGUAGE MACHINE-LEARNED MODELS AND PRESENTING THE QUERIES ON A USER INTERFACE

(71) Applicant: Maplebear Inc., San Francisco, CA (US)

(72) Inventors: Haixun Wang, Bellevue, WA (US); Tejaswi Tenneti, San Carlos, CA (US); Taesik Na, Issaquah, WA (US); Yuanzheng Zhu, Smyrna, GA (US); Vinesh Reddy Gudla, South San Francisco, CA (US); Lee Cohn, Chicago, IL (US)

(21) Appl. No.: 18/587,655

(22) Filed: Feb. 26, 2024

Related U.S. Application Data
(60) Provisional application No. 63/448,626, filed on Feb. 27, 2023.

(51) Int. Cl. G06Q 30/0601

(52) U.S. Cl. CPC G06Q 30/0631; G06Q 30/0627; G06Q 30/0635; G06Q 30/0643

(57) ABSTRACT

Responsive to an input query from a user, an online system presents a list of recommended items that are related to the input query. The input query may be formulated as a natural language query. The online system performs an inference task in conjunction with the model serving system to generate one or more additional queries that are related to the input query and/or are otherwise related to the recommended items presented in response to the input query. The additional queries may be presented to the user in conjunction with the list of recommended items.

### CROSS REFERENCE TO RELATED APPLICATIONS

This application claims the benefit of U.S. Provisional Application No. 63/448,626, filed on Feb. 27, 2023, which is incorporated herein in its entirety.

### BACKGROUND

An online system is an online platform that connects users and providers. For example, a user can place an order for purchasing items from participating providers via the online system. The order of the user includes a list of ordered items. Typically, a user interface (UI) of the online system may have an element where the user can submit a search query for a list of items related to the search query.

### SUMMARY

An online system receives, from a client device, an input query via a search element on a user interface generated on the client device. The online system generates a list of recommended items as a response to the input query, wherein the list of recommended items retrieved are related to the input query and presents the list of recommended items to the user on the user interface. The online system generates a prompt for input to a machine-learned language model, the prompt specifying at least content of the input query or the list of recommended items, and a request to formulate suggested queries related to the input query or the list of recommended items. The online system provides the prompt to a model serving system for execution by the machine-learned language model for execution. The online system receives, from the model serving system, a response generated by executing the machine-learned language model on the prompt. The online system parses the response from the model serving system to extract a set of suggested queries. The online system presents the set of suggested queries on the user interface of the client device adjacent to the list of recommended items on the user interface generated on the client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example search interface generated by the online system for presenting suggested queries, in accordance with an embodiment.

FIG. 4 illustrates an example interface generated by the online system for presenting additional queries, in accordance with an embodiment.

FIG. 5 illustrates an example interface generated by the online system for presenting information related to the additional queries, in accordance with an embodiment.

FIG. 6 is a flowchart illustrating a method of generating additional queries in conjunction with a machine-learned model, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

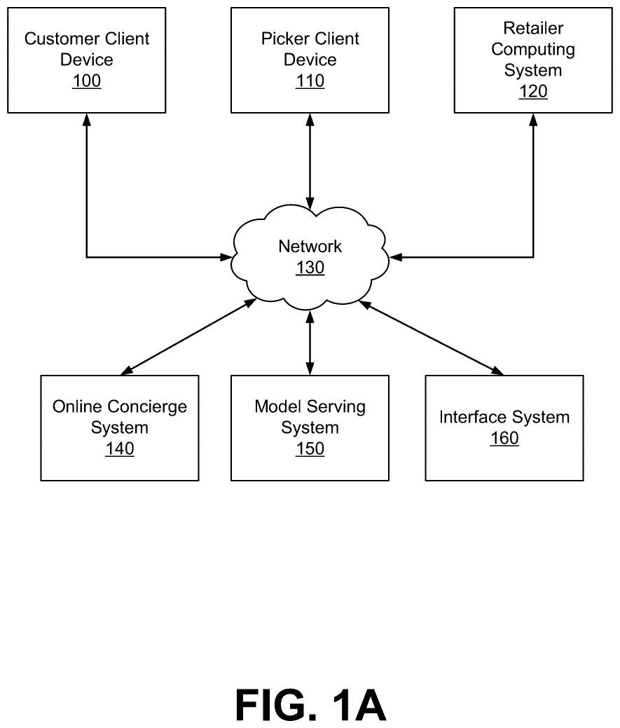

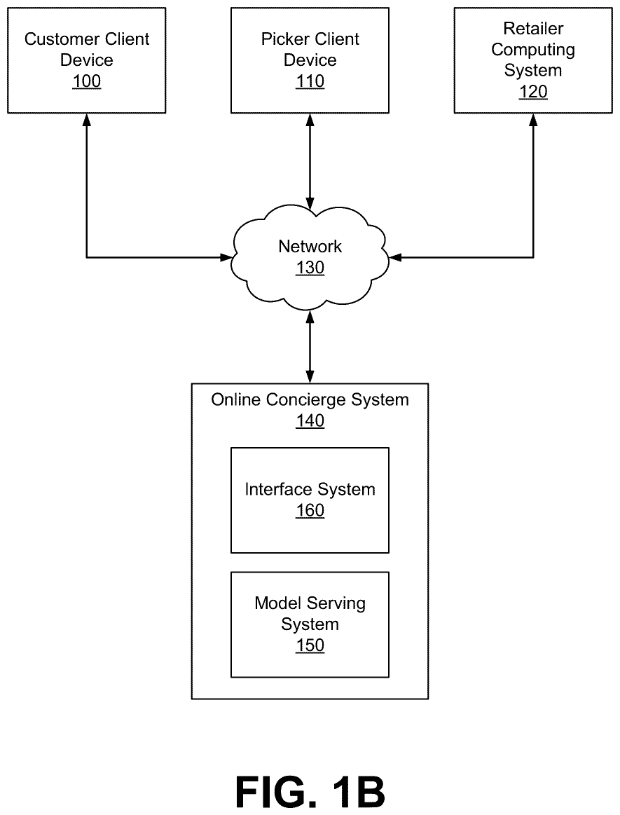

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location.

For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130.

The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

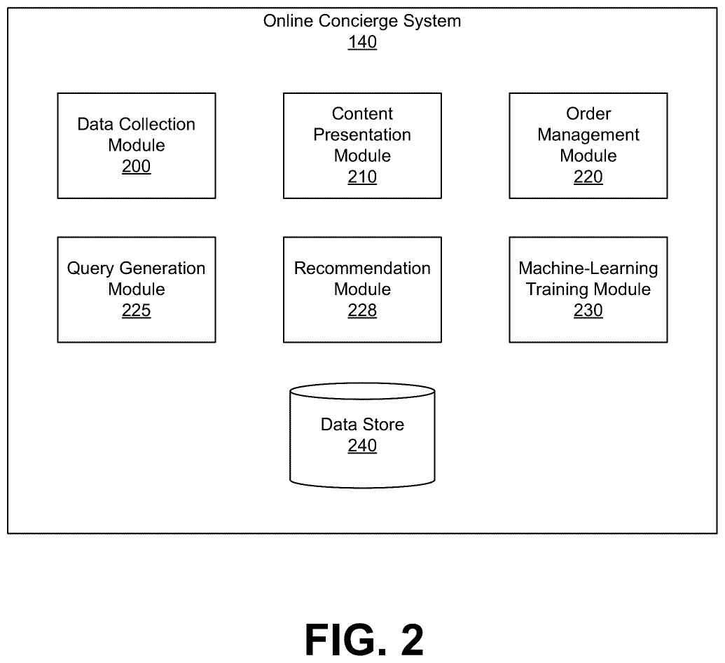

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and hosted on a cloud infrastructure service. The LLM may be trained by the online system 140 or entities different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the task request. The LLM infers the response to the prompt from the knowledge that the LLM was trained on or from the contextual information included in the prompt. In one or more embodiments, the model serving system 150 is configured with one or more application programming interfaces (API's) that allow various users to make requests that are fulfilled with the machine-learned models deployed by the model serving system 150 and obtain responses to those requests. For example, the API's of the model serving system 150 may allow users to integrate various generative AI models, such as LLM's or image generation or analysis models, into their applications.

Responsive to receiving a query from a customer client device 100 or a picker client device 110, the online system 140 can display, as a response to the user's input query, a list of items that are relevant to the query or any other information related to the query. For example, the online system 140 may generate a search interface as part of the ordering interface on a customer client device 100 that the customer can use to enter an input query. In one or more embodiments, the online system 140 performs an inference task in conjunction with the model serving system 150 to generate one or more suggested queries that are related to the input query. In one or more embodiments, the suggested queries are presented to the user in conjunction with the input query within, above, or below the search interface of the online system 140. Responsive to the user selecting a suggested query, the online system 140 can automatically process the selected query and provide a response to the selected query. In this manner, a customer of a customer client device 100 can quickly and easily explore other types of queries that the customer had not considered when searching for the original query.

In one or more embodiments, responsive to a query from a customer client device 100 or a picker client device 110, the online system 140 presents a list of recommended items that are related to the input query. The input query may be formulated as a natural language query. In one or more embodiments, the online system 140 performs an inference task in conjunction with the model serving system 150 to generate one or more additional queries that are related to the input query and/or are otherwise related to the recommended items presented in response to the input query. The additional queries may be presented to the user in conjunction with the list of recommended items, for example, inline, above, or below with the list of recommended items presented to the user.

Responsive to the user selecting an additional query, the online system 140 can automatically process the additional query and provide a response to the selected query. In this manner, a customer of a customer client device 100 can also explore other types of queries while the user is presented with a response to the original input query. While conventional database systems typically process relatively short queries with one or two words, the online system 140 described herein can also receive queries from users that are natural language queries resembling natural language than conventional queries and processes the queries in conjunction with a large-scale machine-learned language model to generate a list of recommended items for the user. Compared to conventional queries, the natural language queries may incorporate intent of a user in a better way than conventional queries and therefore, be used to retrieve items that are more relevant to the user's intention.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus from the online system 140 and builds a structured index over the data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources as well as provide a flexible connector to the external corpus.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a purpose determination module 225, a recommendation module 228, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, responsive to an input query received via a search interface, the content presentation module 210 receives one or more suggested queries related to the input query. In one or more embodiments, the suggested queries are presented to the user in conjunction with the input query within, above, or below the search interface.

In one or more embodiments, responsive to an input query received via a search interface, the content presentation module 210 receives a list of recommended items as a response to the input query. The content presentation module 210 also receives a list of one or more additional queries related to the input query or related to the list of recommended items. In one or more embodiments, the one or more additional queries may be presented to the user in conjunction with the list of recommended items, for example, inline, above, or below with the list of recommended items presented to the user.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110.

The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

Responsive to receiving an indication of an input query from a customer through the ordering interface, the query generation module 225 performs an inference task in conjunction with the model serving system 150 to generate one or more suggested queries that are related to the input query. Specifically, the query generation module 225 generates a prompt that includes a request of the inference task to be performed by the machine-learned model and contextual information for completing the inference task.

In one or more embodiments, the prompt generated by the query generation module 225 includes a request to infer suggested queries that are other queries related to the original input query of the user. For example, the suggested queries for an input query on a product category or recipe may be queries on what other products or recipes go with the product category or recipe, how to make a particular recipe, suggestions for substitute or optimal ingredients for a recipe, and the like. For example, an example prompt to an LLM may be:
“What are other suggested queries (in natural language) that are related to a query on “fish tacos”?

The query generation module 225 receives an output from the machine-learned model of the model serving system 150 as a response to the prompt. The query generation module 225 extracts one or more suggested queries from the output of the machine-learned model and provides the information to the content presentation module 210. While the output of an LLM may be formatted, for example, in a dialogue format, the query generation module 225 parses the output to extract meaningful information describing the suggested queries. The suggested queries may be presented to the user in conjunction with the input query within, above, or below the search interface by the content presentation module 210.

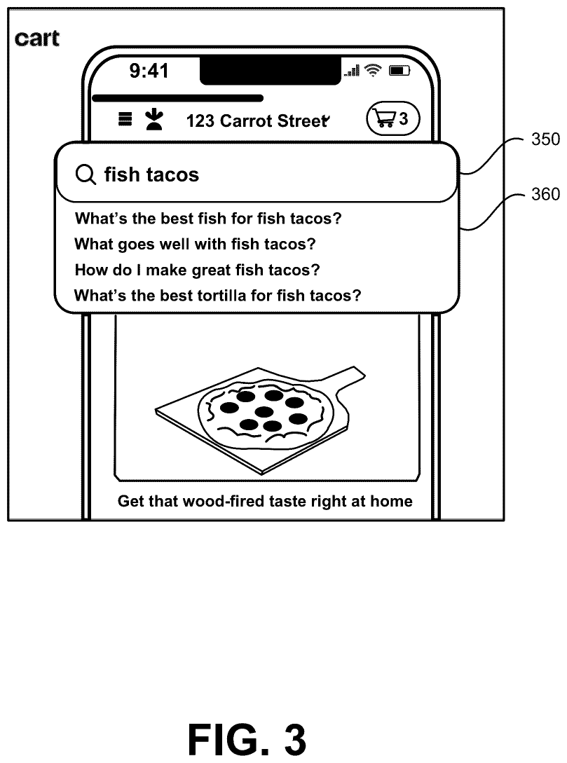

FIG. 3 illustrates an example search interface generated by the online system 140 for presenting suggested queries, in accordance with an embodiment. In one or more embodiments, the example interface shown in FIG. 3 may be generated by the content presentation module 210.

Responsive to a customer inputting “fish tacos” in the search interface 350, the online system 140 presents suggested queries: “What's the best fish for fish tacos?,”“What goes well with fish tacos?,”“How do I make great fish tacos?,”“What's the best tortilla for fish tacos?” that are related queries to the original query requesting input on ingredients for a fish taco recipe or guidance on how to make the recipe, and the like. As shown in FIG. 3, the suggested queries may be presented in an element 360 below the input query as the user is entering in the input query but it is appreciated that in other examples, the suggested queries may be presented anywhere on the interface as appropriate. In one instance, the suggested queries extracted from the response of the LLM are natural language queries or semantic queries.

In one or more embodiments, the query generation module 225 performs an inference task in conjunction with the model serving system 150 to generate one or more additional queries that are related to the input query or are otherwise related to the recommended items presented in response to the input query. Specifically, the query generation module 225 generates a prompt that includes a request of the inference task to be performed by the machine-learned model and contextual information for completing the inference task.

In one or more embodiments, the prompt generated by the query generation module 225 includes a request to formulate related queries that are queries related to the original input query of the user, additional ideas for consideration for the user, and/or queries related to the list of recommended items provided to the user as a response to the input query. For example, the additional queries for an input query on how to make a particular recipe may be queries on what other items go with the recipe, suggestions for substitute or optimal ingredients for a recipe, and the like. For example, an example prompt to an LLM may be:
“What are other queries or ideas (in natural language) that are related to a query on “How do I make great fish tacos”?

As another example, an example prompt to an LLM may be
“What are other queries or ideas (in natural language) that are related to a list of items including red onion, jalapeno pepper, cilantro, and red pepper?

The query generation module 225 receives an output from the machine-learned model of the model serving system 150 as a response to the prompt. The query generation module 225 extracts one or more additional queries from the output of the machine-learned model and provides the information to the content presentation module 210. While the output of an LLM may be formatted, for example, in a dialogue format, the query generation module 225 parses the output to extract meaningful information describing the additional queries. The additional queries may be presented to the user in conjunction with the list of recommended items, for example, inline, above, or below with the list of recommended items presented to the user. Thus, the additional queries may be presented as part of a response to the input query of the user. The query generation module 225 may provide the prompt via an API call and receive the output from the API of the model serving system 150.

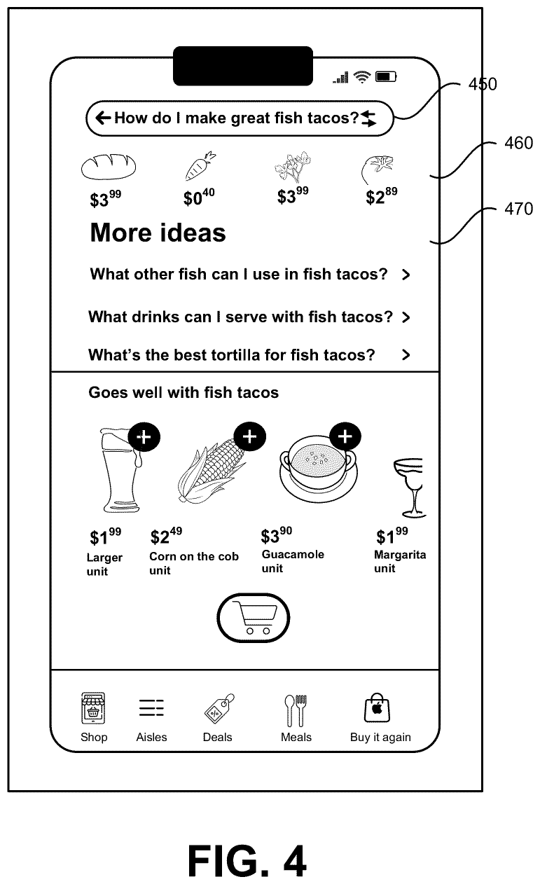

FIG. 4 illustrates an example interface generated by the online system 140 for presenting additional queries, in accordance with an embodiment. In one or more embodiments, the example interface shown in FIG. 4 may be generated by the content presentation module 210.

Responsive to a customer inputting “How do I make great fish tacos?” in the search interface 450, the online system 140 presents a list of recommended items 460 including bread, carrots, parsley, and the like that are suggested to be included in a great fish taco recipe and that the customer can select to add to the customer's basket for an order.

The online system 140 also presents under a separate user interface component 470 under “More ideas” a list of additional queries “What other fish can I use in fish tacos,”“What drinks can I serve with fish tacos?,”“What's the best tortilla for fish tacos?” that are related queries or ideas that the user can consider in addition to the input query and the list of recommended items.

As shown in FIG. 4, the additional queries may be presented below at least a portion of the list of recommended items as a response to the original input query, but it is appreciated that in other examples, the additional (suggested) queries may be presented anywhere on the interface as appropriate. For example, in other embodiments, the additional queries may be presented above the list of recommended items or in-line with the list of recommended items, and the like.

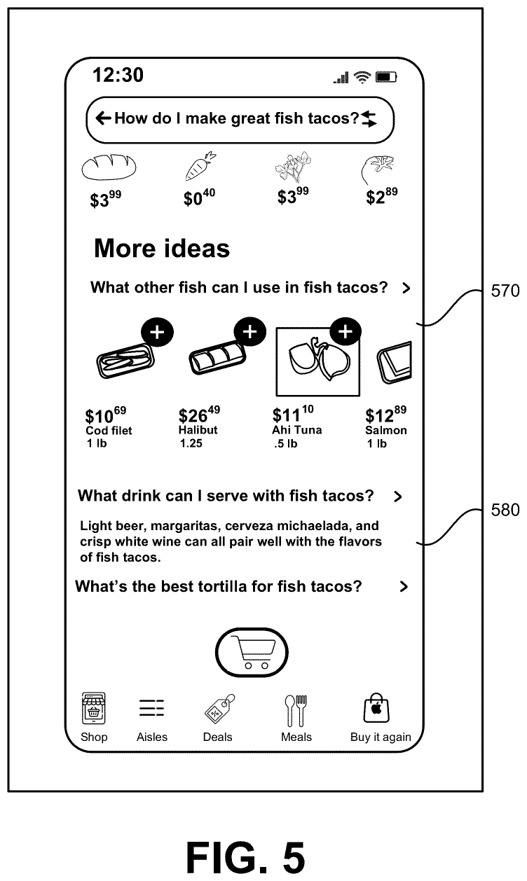

FIG. 5 illustrates an example interface generated by the online system 140 for presenting information related to the additional (suggested) queries, in accordance with an embodiment. As shown in FIG. 5, each of the additional queries can be displayed as a collapsible/expandable panel. Responsive to a user interacting (e.g., clicking or hovering over) the suggested query “What other fish can I use in fish tacos?,” the online system 140 generates a second list of recommended items that are related to the suggested query. The second list of recommended items are shown in a panel 570 expanded below the suggested query. The user can click on an item to add the item to the user's order or click on the item to obtain more information about the item.

As shown in FIG. 5, responsive to a user interacting with the suggested query “What drinks can I serve with fish tacos?,” the online system 140 generates a text-based response that includes example drinks that can be served with fish tacos. For example, the online system 140 may generate the text-based answer in conjunction with an LLM. The textual response is presented to the user in a panel 580 that expands below the suggested query.

While conventional user interfaces for inputting and presenting queries may simply provide suggestions for auto-completion on the search interface, the interfaces described herein (e.g., FIG. 4 or 5) may present a subset of suggested queries that are deemed to be relevant to the input query or recommended items generated in response to the input query. The online system 140 organizes and arranges the suggested queries on the interface to be placed adjacent to a list of recommended items. This way, the user can consider the additional queries in conjunction with the list of recommended items and select an additional query to get a new list of recommended items. In this way, a technical improvement can be made over prior online systems and results in an improved UI for search and retrieval interface.

In one or more embodiments, the online system 140 may additionally fine-tune parameters of the machine-learned language model using multiple instances of training data. An instance in the training data may include a previous input query or a list of items that were recommended to a user and one or more instances of additional queries that are deemed to be related to the input query or the items. For example, the one or more additional queries in the training data may be determined by presenting suggested queries to a user and obtaining the suggested queries that the user interacted with. The online system 140 generates estimated outputs using the input queries of the training data and computes a loss function based on the estimated outputs and the additional queries in the training data. The errors obtained from the loss function are backpropagated to update parameters of the machine-learned model.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function.

For example, the machine learning training module 230 may apply gradient descent to update the set of parameters.

The data store 240 stores data used by the online system 140. For example, the data store 240 stores customer data, item data, order data, and picker data for use by the online system 140.

The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

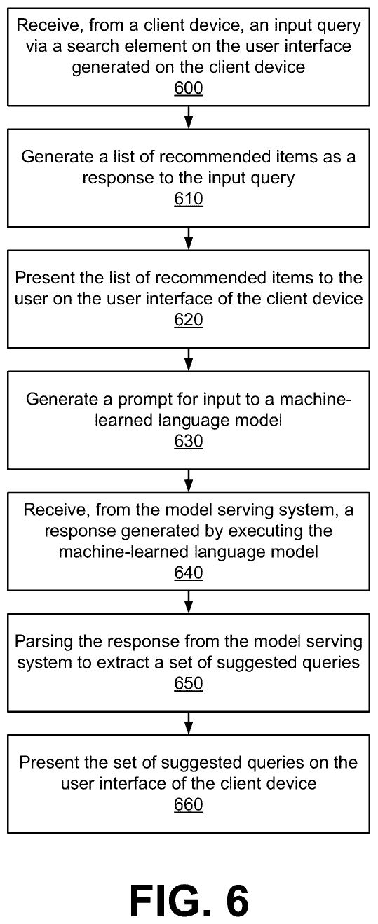

FIG. 6 is a flowchart illustrating a method of generating additional queries in conjunction with a machine-learned model, in accordance with an embodiment. The online system 140 receives 600, from a client device, an input query via a search element on a user interface generated on the client device. The online system 140 generates 610 a list of recommended items as a response to the input query, wherein the list of recommended items retrieved are related to the input query. The online system 140 presents 620 the list of recommended items to the user on the user interface of the client device. The online system 140 generates 630 a prompt for input to a machine-learned language model, the prompt specifying at least content of the input query or the list of recommended items, and a request to formulate suggested queries related to the input query or the list of recommended items. The online system 140 provides the prompt to a model serving system for execution by the machine-learned language model. The online system 140 receives 640, from the model serving system, a response generated by executing the machine-learned language model on the prompt. The online system 140 parses 650 the response from the model serving system to extract a set of suggested queries. The online system 140 presents 660 the set of suggested queries on the user interface of the client device adjacent to the list of recommended items.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter.

It is therefore intended that the scope of the patent rights be limited not by this detailed description, but rather by any claims that issue on an application based hereon.

As used herein, the terms “comprises,”“comprising,”“includes,”“including,”“has,”“having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a client device, an input query via a search element on a user interface generated on the client device;
generating a list of recommended items as a response to the input query, wherein the list of recommended items retrieved are related to the input query;
presenting the list of recommended items to a user on the user interface of the client device;
generating a prompt for input to a machine-learned language model, the prompt specifying at least content of the input query or the list of recommended items, and a request to formulate suggested queries related to one or more of: the input query or the list of recommended items;
providing the prompt to a model serving system for execution by the machine-learned language model;
receiving, from the model serving system, a response generated by executing the machine-learned language model on the prompt;
parsing the response from the model serving system to extract a set of suggested queries; and
presenting the set of suggested queries on the user interface of the client device adjacent to the list of recommended items.

2. The method of claim 1, wherein the set of suggested queries are placed below the list of recommended items or above the list of recommended items on the user interface.

3. The method of claim 1, further comprising:
responsive to receiving an interaction from the user with a suggested query on the user interface, presenting a second list of recommended items on the user interface of the client device, wherein the second list of recommended items are related to the suggested query and comprise a response to the suggested query.

4. The method of claim 3, wherein presenting the second list of recommended items comprises:
generating or expanding a panel UI element below the suggested query and presenting the second list of recommended items within the panel.

5. The method of claim 1, further comprising:
obtaining a second set of suggested queries related to the input query; and
generating a dropdown element below a search interface presenting the second set of suggested queries to the user.

6. The method of claim 1, wherein providing the prompt comprises making an application programming interface (API) call to an API of the model serving system.

7. The method of claim 1, wherein the machine-learned language model has a transformer architecture including one or more attention layers.

8. A non-transitory computer-readable storage medium storing instructions that when executed by a computer processor cause the computer processor to perform steps comprising:
receiving, from a client device, an input query via a search element on a user interface generated on the client device;
generating a list of recommended items as a response to the input query, wherein the list of recommended items retrieved are related to the input query;
presenting the list of recommended items to the user on the user interface of the client device;
generating a prompt for input to a machine-learned language model, the prompt specifying at least content of the input query or the list of recommended items, and a request to formulate suggested queries related to the input query or the list of recommended items;
providing the prompt to a model serving system for execution by the machine-learned language model;
receiving, from the model serving system, a response generated by executing the machine-learned language model on the prompt;
parsing the response from the model serving system to extract a set of suggested queries; and
presenting the set of suggested queries on the user interface of the client device adjacent to the list of recommended items.

9. The non-transitory computer-readable storage medium of claim 8, wherein the set of suggested queries are placed below the list of recommended items or above the list of recommended items on the user interface.

10. The non-transitory computer-readable storage medium of claim 8, the instructions further comprising:
responsive to receiving an interaction from the user with a suggested query on the user interface, presenting a second list of recommended items on the user interface of the client device, wherein the second list of recommended items are related to the suggested query and comprise a response to the suggested query.

11. The non-transitory computer-readable storage medium of claim 10, wherein instructions for presenting the second list of recommended items comprises:
generating or expanding a panel UI element below the suggested query and presenting the second list of recommended items within the panel.

12. The non-transitory computer-readable storage medium of claim 8, the instructions further comprising:
obtaining a second set of suggested queries related to the input query; and
generating a dropdown element below a search interface presenting the second set of suggested queries to the user.

13. The non-transitory computer-readable storage medium of claim 8, wherein instructions for providing the prompt comprises making an application programming interface (API) call to an API of the model serving system.

14. The non-transitory computer-readable storage medium of claim 8, wherein the machine-learned language model has a transformer architecture including one or more attention layer.

15. A computer system, the computer system comprising:
a computer processor; and
a non-transitory computer-readable storage medium storing instructions that when executed by the computer processor cause the computer processor to perform steps comprising:
receiving, from a client device, an input query via a search element on a user interface generated on the client device;
generating a list of recommended items as a response to the input query, wherein the list of recommended items retrieved are related to the input query;
presenting the list of recommended items to the user on the user interface of the client device;
generating a prompt for input to a machine-learned language model, the prompt specifying at least content of the input query or the list of recommended items, and a request to formulate suggested queries related to the input query or the list of recommended items;
providing the prompt to a model serving system for execution by the machine-learned language model;
receiving, from the model serving system, a response generated by executing the machine-learned language model on the prompt;
parsing the response from the model serving system to extract a set of suggested queries; and
presenting the set of suggested queries on the user interface of the client device adjacent to the list of recommended items.

16. The computer system of claim 15, wherein the set of suggested queries are placed below the list of recommended items or above the list of recommended items on the user interface.

17. The computer system of claim 15, the instructions further comprising:
responsive to receiving an interaction from the user with a suggested query on the user interface, presenting a second list of recommended items on the user interface of the client device, wherein the second list of recommended items are related to the suggested query and comprise a response to the suggested query.

18. The computer system of claim 17, wherein instructions for presenting the second list of recommended items comprises:
generating or expanding a panel UI element below the suggested query and presenting the second list of recommended items within the panel.

19. The computer system of claim 15, the instructions further comprising:
obtaining a second set of suggested queries related to the input query; and
generating a dropdown element below a search interface presenting the second set of suggested queries to the user.

20. The computer system of claim 15, wherein instructions for providing the prompt comprises making an application programming interface (API) call to an API of the model serving system.
